(19) United States
(12) Patent Application Publication
(10) Pub. No.: US 2009/0327644 A1
(43) Pub. Date: Dec. 31, 2009

(54) CPU AND MEMORY CONNECTION ASSEMBLY TO EXTEND MEMORY ADDRESS SPACE

(75) Inventors: Joo-Hyeong Lee, Seoul (KR); Jae-Yong Lee, Anyang-si (KR)

Correspondence Address: MCDERMOTT WILL & EMERY LLP, 600 13TH STREET, N.W., WASHINGTON, DC, 20005-3096, US

(73) Assignee: SDC MICRO INC.

(21) Appl. No.: 12/492,698

(22) Filed: Jun. 26, 2009

(30) Foreign Application Priority Data
Jun. 26, 2008 (KR) 10-2008-0061218

(51) Int. Cl. G06F 12/00

(52) U.S. Cl. 711/202; 711/E12.001

(57) ABSTRACT

Disclosed is a CPU and memory connection assembly to extend memory address space without extending address pins. The CPU and memory connection assembly extends entire accessible memory address of a CPU using a small number of address pins by synthesizing a final memory address by receiving an offset address setting command inputted from a CPU through an offset address decoder to generate an offset address and by receiving CPU max address bit setting command directly inputted from the CPU through an address synthesizer to combine the CPU max address bit setting command with the address directly inputted from the CPU.

### BACKGROUND OF THE INVENTION

1. Field of the Invention

The present invention relates to a CPU and memory connection assembly to extend memory address space without extending address pins, and more particularly to, a CPU and memory connection assembly for extending entire accessible memory address of a CPU using a small number of address pins by synthesizing a final memory address by receiving an offset address setting command inputted from a CPU through an offset address decoder to generate an offset address and by receiving CPU max address bit setting command directly inputted from the CPU through an address synthesizer to combine the CPU max address bit setting command with the address directly inputted from the CPU.

2. Description of the Related Art

A NOR flash memory generally has address pins corresponding to memory capacity. To access the NOR flash memory, the CPU inputs a memory address to the address pins, and then reads or writes data at the memory address.

When the number of address pins is less than memory capacity, entire memory space cannot be used due to the limited number of accessible memory addresses. Thus, when entire system is designed with a CPU using a NOR flash memory, a designer uses a NOR flash memory having a corresponding capacity to be accessible by address pins of a CPU.

In recent, since application programs requiring high capacity memory are increased and memory technology is advanced, a memory having a capacity higher than capacity accessible through the fixed number of address pins of the CPU is needed. For this, a product is to be redesigned with a CPU which can use a high capacity memory.

### BRIEF SUMMARY OF THE INVENTION

The present invention has been made in view of the above problems, and provides a CPU and memory connection assembly for extending entire accessible memory address of the CPU using a small number of address pins by synthesizing a final memory address by receiving an offset address setting command inputted from a CPU through an offset address decoder to generate an offset address and by receiving CPU max address bit setting command directly inputted from the CPU through an address synthesizer to combine the CPU max address bit setting command with the address directly inputted from the CPU.

In order to achieve the above mentioned aspect of the present invention, the present invention provides a CPU and memory connection assembly including: a CPU generating and transmitting a memory address and data; and a memory IC chip connected to the CPU for the communication and reading the memory address and the data to be read by the CPU to generate a final memory address to be used as an address for accessing a memory cell. The memory IC chip includes: an offset address decoder selecting and storing an offset address to be transmitted as an analysis command factor when an offset address setting command is input during monitoring the memory address and the data output from the CPU; an address synthesizer receiving the offset address detected from the offset address decoder and the memory address and the data output from the CPU to synthesize the final memory address by combining the offset address with the memory address; and the memory cell from which the stored data is read through the final memory address generated by the address synthesizer.

The address synthesizer generates the final memory address, and allocates a memory address directly transmitted from the CPU in a least significant bit (LSB), the offset address in a most significant bit (MSB); and sets a boundary position between the memory address and the offset address by memory configuration setting command. The address synthesizer monitors the data and the memory address input from the CPU and sets a corresponding CPU address range by analyzing a CPU max bit setting command when the CPU max bit setting command is input, and the final memory address is generated by allocating the offset address as the most significant bit to a preset CPU address.

According to the present invention, two components are added to a memory IC chip such that a storage memory with capacity exceeding memory capacity of address pins of the CPU may be used. Therefore, a designing period for the entire system is reduced and the design cost is also reduced.

### BRIEF DESCRIPTION OF THE DRAWINGS

FIG. 1 is a block diagram illustrating a CPU and memory connection assembly according to an embodiment of the present invention; and

FIG. 2 is a view illustrating a result of a generated final memory address according to the embodiment of the present invention.

### DETAILED DESCRIPTION OF THE INVENTION

Hereinafter, a CPU and memory connection assembly according to an embodiment of the present invention will be described in detail with accompanying drawings.

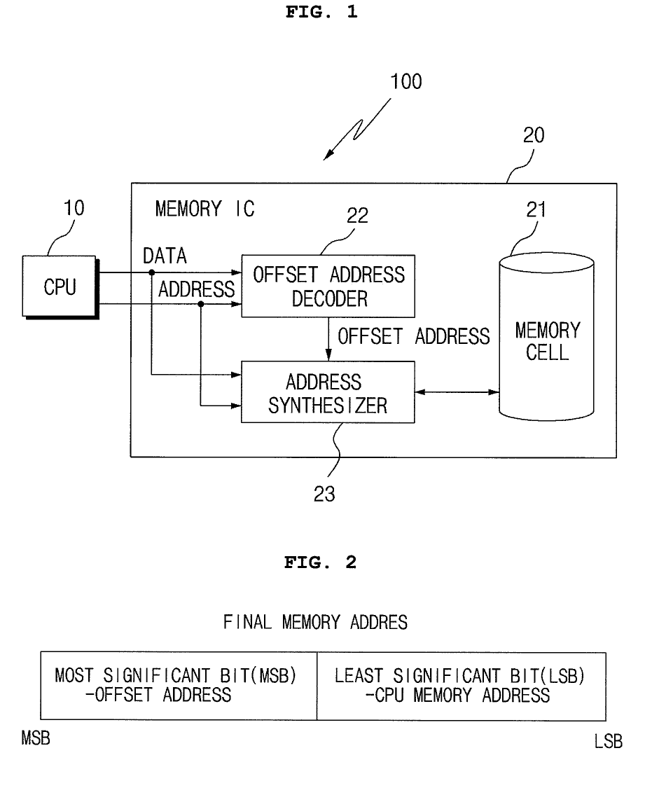

FIG. 1 is a block diagram illustrating a CPU and memory connection assembly according to an embodiment of the present invention. FIG. 2 is a view illustrating a result of a generated final memory address according to the embodiment of the present invention.

Referring to the drawings, a CPU and memory connection assembly 100 according to an embodiment of the present invention includes a CPU 10 generating and transmitting memory addresses and data to a memory IC chip 20 to be connected thereto for communication; and the memory IC chip 20 reading a memory address from which stored data is read from the CPU 10 and data to generate a final memory address to access a memory cell 21 that is provided in the memory IC chip 20. The memory IC chip 20 includes an offset address decoder 22 storing an offset address, which is transmitted as an analysis command factor, selected from offset address setting command to analysis commands factor during monitoring the memory addresses and data outputted from the CPU 10, an address synthesizer 23 receiving the offset address detected from the offset address decoder 22 and the memory address and the data output from the CPU 10 to synthesize the final memory addresses by combining the offset address and a CPU memory address, and a memory cell 21 from which the stored data is read through the final memory address generated by the address synthesizer 23.

Here, the CPU 10 generates the memory address to read data stored in the memory cell 21 and then transmits the generated memory address to the memory IC chip 20. The CPU 10 transmits the offset address setting command and the CPU max address bit setting command together in data form to the memory IC chip 20.

The offset address setting command is generated to transmit the offset address in the form of a command factor while the CPU max address bit setting command is a command factor generated to set a CPU address range.

By doing so, the offset address decoder 22 provided in the memory IC chip 20 monitors the data and the memory addresses which are transmitted from the CPU 10. When the offset address setting command is input, the offset address decoder 22 analyzes the offset address setting command, selects the offset address therefrom and transmits the selected offset address to the address synthesizer 23.

The address synthesizer 23 combines the offset address transmitted from the offset address decoder 22 and the CPU memory address directly transmitted from the CPU 10 to generate a final memory address to be read from the memory cell 21.

The memory address and the data transmitted from the CPU 10 are transmitted to the offset address decoder 22 and the address synthesizer 23, respectively such that a process of generating the offset address and the final memory address is performed.

Furthermore, the process of generating a final memory address, performed in the address synthesizer 23, is carried out by firstly allocating the memory address directly transmitted from the CPU 10 a least significant bit (LSB) and by allocating the offset address transmitted from the offset address decoder 22 to a most significant bit (referred to as MSB). At this time, a boundary position between the two addresses is set by a memory configuration setting command.

The address synthesizer 23 monitors the data and the memory address of the CPU 10. When the CPU max bit setting command (CPU address range setting command) is input, the address synthesizer 23 set a corresponding CPU address range and allocates the offset address as the MSB to a preset CPU address to generate the final memory address.

This final memory address is used as an address for accessing the memory cell 21 that is provided in the memory IC chip 20 to read the stored data.

Although exemplary embodiments of the present invention have been described in detail hereinabove, it should be understood that many variations and modifications of the basic inventive concept herein described, which may appear to those skilled in the art, will still fall within the spirit and scope of the exemplary embodiments of the present invention as defined by the appended claims.

What is claimed is:

1. A CPU and memory connection assembly comprising;
a CPU generating and transmitting a memory address and data; and
a memory IC chip connected to the CPU for the communication and reading the memory address and the data to be read by the CPU to generate a final memory address to be used as an address for accessing a memory cell;
wherein
the memory IC chip comprises;
an offset address decoder selecting and storing an offset address to be transmitted as an analysis command factor when an offset address setting command is input during monitoring the memory address and the data output from the CPU;
an address synthesizer receiving the offset address detected from the offset address decoder and the memory address and the data output from the CPU to synthesize the final memory address by combining the offset address with the memory address; and
the memory cell from which the stored data is read through the final memory address generated by the address synthesizer.

2. The CPU and memory connection assembly in claim 1, wherein the address synthesizer, during the generation of the final memory address, allocates a memory address directly transmitted from the CPU in a least significant bit (LSB), allocates the offset address in a most significant bit, and sets a boundary position between the memory address and the offset address by a memory configuration setting command.

3. The CPU and memory connection assembly in claim 2, wherein the address synthesizer monitors the data and the memory address input from the CPU 10 and sets a corresponding CPU address range by analyzing a CPU max bit setting command when the CPU max bit setting command is input, and
the final memory address is generated by allocating the offset address as the most significant bit to a preset CPU address.
